(19) United States
(12) Patent Application Publication
(10) Pub. No.: US 2011/0085044 A1
(43) Pub. Date: Apr. 14, 2011

(54) IMAGE DISPLAY APPARATUS WITH EXTERNAL-EQUIPMENT-LINK UNIT

(75) Inventors: Hitoshi NODA, Osaka (JP); Tamotsu AKEYAMA, Osaka (JP); Makoto KIKUCHI, Osaka (JP)

(73) Assignee: Panasonic Corporation, Osaka (JP)

(21) Appl. No.: 12/904,213

(22) Filed: Oct. 14, 2010

(30) Foreign Application Priority Data
Oct. 14, 2009 (JP) JP 2009-236936

(51) Int. Cl. H04N 17/00; H04N 5/66

(52) U.S. Cl. 348/189; 348/739; 348/E05.133; 348/E17.001

(57) ABSTRACT

An image display apparatus includes: an image display unit for forming and displaying an optical image; an external-equipment-link unit capable of sending/receiving a control signal to/from external equipment; and a control unit for controlling operations of the image display unit and the external-equipment-link unit. The external-equipment-link unit includes at least one control signal output circuit and at least one control signal input circuit, the control signal input circuit detects an input control signal inputted from the external equipment and supplies the input control signal to the control unit. The control unit controls the control signal output circuit to output an external equipment control signal to the external equipment in response to the image display apparatus being in a predetermined operation state, and the control unit controls operations of the image display apparatus based on the input control signal supplied from the control signal input circuit. Not only the operations of the external equipment can be controlled from the image display apparatus but also the operations of the image display apparatus can be controlled from the external equipment, which improves user convenience.

### BACKGROUND OF INVENTION

1. Field of the Invention

The present invention relates to an image display apparatus, which is provided with an external-equipment-link unit for controlling operations of external equipment from the image display apparatus or controlling operations of the image display apparatus from the external equipment.

2. Description of Related Art

As videodisk players and the like have become widely available in recent years, there is an increase in demand for large-screen image display apparatuses that can display vibrant large-screen images. Among large-screen image display apparatuses, for example, a projector as a projection type image display apparatus is known. By using a projector and a screen in combination, large-screen images can be displayed. In a case where a projector and a screen are used in combination, the screen generally is retracted to avoid damage to the screen surface while no image viewing is performed. The screen is taken out and extended when it is used. Since the screen needs to be retracted again after the use, a user is required to carry out burdensome operations, i.e., extension/retraction of the screen, every time viewing is performed.

Thus, to make extension/retraction of the screen easy, it has been contemplated to use motors, switches and the like to extend/retract a screen. Further, to make the operation easier, there has been proposed a device in which a projector as an image display apparatus and an audio amplifier as an audio apparatus are provided with a control signal output circuit, and a control signal is outputted in accordance with operations of the projector and the audio apparatus. That is, the device is configured such that a screen is extended/retracted in conjunction with operations of the apparatuses using the externally outputted control signal.

In this way, a projector including an external equipment control unit for controlling external equipment is described in JP H9-325422 A, for example. FIG. 4 is a diagram showing a configuration of the external equipment control unit (first conventional example) included in the projector.

As shown in FIG. 4, an image signal source 101 is connected to a projector 100, so that desired images can be projected. A screen 102 is placed facing the projector 100. The screen 102 is extended from and retracted into an extending/retracting device 110. The extending/retracting device 110 includes: a motor 113 for extending/retracting the screen 102; a control circuit 111; and a driving circuit 112 for the motor 113. An image signal is supplied to the control circuit 111 from the image signal source 101.

The external equipment control unit of the image display apparatus in the first conventional example configured as in FIG. 4 operates as follows. An image signal from the video signal source 101 is inputted to the projector 100 as well as the control circuit 111 of the extending/retracting device 110, so that the control circuit 111 determines the presence or absence of the image signal. When the image signal is present, the control circuit 111 generates a control signal that causes the driving circuit 112 to drive the motor 113 to extend the screen 102. On the other hand, when the image signal is not present, the control circuit 111 generates a control signal that causes the driving circuit 112 to drive the motor 113 to retract the screen 102. In this way, the external equipment control unit of the image display apparatus disclosed in JP H9-325422 A controls extension/retraction of the screen in accordance with the presence or absence of the image signal.

Further, there also has been proposed an external equipment control unit (second conventional example) that generates a control signal to external equipment in conjunction with operations of a projector. FIG. 5 is a diagram showing an exemplary configuration of the external equipment control unit in the second conventional example.

In FIG. 5, the same components as those shown in FIG. 4 are denoted by the same reference numerals and the description thereof will not be repeated. In this configuration, a projector 100 is provided with a control circuit as a part of the functions of a microcomputer 105, an external equipment control signal output circuit 106 and a control signal output terminal 107, all of which constitute the external equipment control unit.

The external equipment control unit of the image display apparatus in the second conventional example as shown in FIG. 5 operates as follows. When the projector 100 is in an ON state, the control circuit 105 controls the external equipment control signal output circuit 106 to output a control signal. On the other hand, when the projector 100 is in an OFF state, the control circuit 105 controls the external equipment control signal output circuit 106 not to output a control signal. By controlling a screen extending/retracting device 110 using the control signal configured as described above, a screen can be extended/retracted automatically.

As described above, in the external equipment control unit of the image display apparatus in the first conventional example, extension/retraction of the screen is controlled on the basis of the presence or absence of an image signal, meaning that extension/retraction of the screen is linked not to operations of the projector but to operations of the signal source. Thus, when no image signal is outputted for the time being as a result of switching image signals, the screen may be retracted in conjunction with the no-signal state.

On the other hand, in the external equipment control unit in the second conventional example configured to generate a control signal to external equipment in conjunction with operations of the projector, since the screen is extended/retracted in conjunction with operations of the projector, the above-mentioned problem does not occur.

By the way, an aspect ratio (a length-to-width ratio of an image) used for recent images is not one type and a variety of aspect ratios have been used. Thus, there is a demand for using a screen corresponding to the aspect ratio of images to be displayed. To meet such a demand, a proper screen is chosen from a plurality of screens with different aspects on the basis of the aspect ratio of images to be displayed.

On the other hand, the external equipment control units of the conventional image display apparatuses are configured only to output a control signal, so that they are capable of performing such control as extension/retraction of a screen but are incapable of controlling an image display apparatus, for example, to perform picture muting for not displaying images while the screen is changed in accordance with the aspect ratio of images to be displayed. This causes a problem of giving an impression that the projector has a poor image display quality, because images are displayed during the screen changing.

Further, it is not always possible to regulate what external circuit users may connect to the control signal output terminal of the projector. Thus, if a user connects, to the terminal, an external circuit incompatible with the rating of the control signal output circuit, an overcurrent may flow into the control signal output circuit of the projector, and accidents such as the projector catching fire or producing smoke may occur.

### SUMMARY OF THE INVENTION

With the foregoing in mind, it is an object of the present invention to provide an image display apparatus, which is provided with an external-equipment-link unit that allows not only the control of operations of external equipment from the image display apparatus but also the control of the image display apparatus from the external equipment. Another object of the present invention is to provide an image display apparatus with an external-equipment-link-unit that can avoid being impacted significantly even if an external circuit of external equipment connected to the control signal output circuit has incompatible specifications.

In order to achieve the above-described objects, the image display apparatus of the present invention includes: an image display unit for forming and displaying an optical image; an external-equipment-link unit capable of sending/receiving a control signal to/from external equipment; and a control unit for controlling operations of the image display unit and the external-equipment-link unit. The external-equipment-link unit includes at least one control signal output circuit and at least one control signal input circuit, the control signal input circuit detects an input control signal inputted from the external equipment and supplies the input control signal to the control unit. The control unit controls the control signal output circuit to output an external equipment control signal to the external equipment in response to the image display apparatus being in a predetermined operation state, and the control unit controls operations of the image display apparatus based on the input control signal supplied from the control signal input circuit.

As described above, with the external equipment control circuit of the image display apparatus of the present invention, operations of a projector as the image display apparatus can be controlled from the external equipment. Thus, it is possible to improve user convenience.

### BRIEF DESCRIPTION OF THE DRAWINGS

FIG. 1 is a block diagram for explaining a configuration of an image display apparatus with an external-equipment-link unit according to Embodiment 1 of the present invention and operations when controlling external equipment.

FIG. 2 is a block diagram for explaining operations when the image display apparatus is controlled from the external equipment.

FIG. 3 is a block diagram for explaining operations when controlling external equipment from an image display apparatus with an external-equipment-link unit according to Embodiment 2 of the present invention.

FIG. 4 is a block diagram showing an external equipment control unit of an image display device in a conventional example.

FIG. 5 is a block diagram showing an external equipment control unit of an image display device in other conventional example.

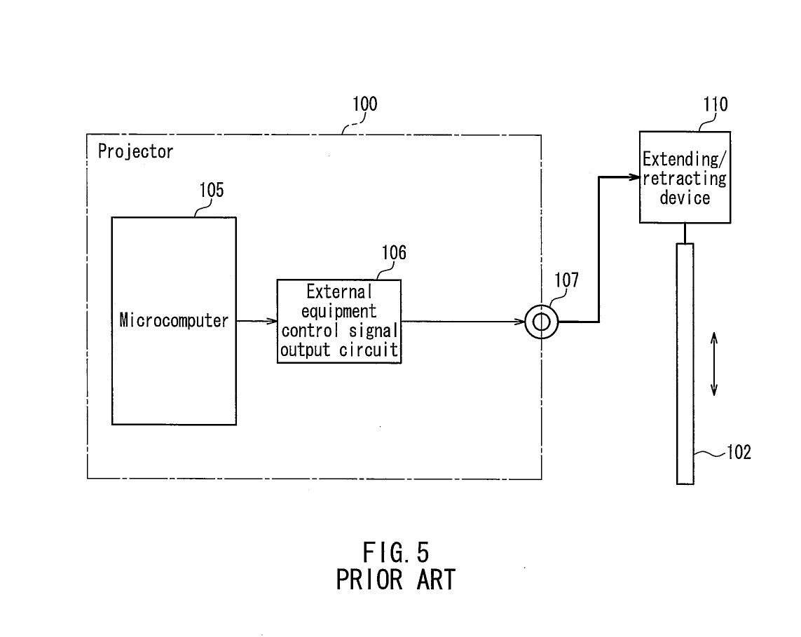

### DETAILED DESCRIPTION OF THE INVENTION

Based on the configuration as mentioned above, the image display apparatus of the present invention can be modified as follows.

That is, it is preferable that the operation of the control signal output circuit to output the external equipment control signal to the external equipment and the operation of controlling operations of the image display apparatus based on the input control signal detected by the control signal input circuit can be enabled or disabled independently.

Further, the external-equipment-link unit may include a plurality of pairs of the control signal output circuits and the control signal input circuits, and for each pair of the control signal output circuit and the control signal input circuit, the operation of the control signal output circuit to output the external equipment control signal to the external equipment and the operation of controlling the operations of the image display apparatus based on the input control signal detected by the control signal input circuit can be enabled or disabled independently.

Further, the image display apparatus of the present invention may have a menu function for selecting the operations of the image display apparatus, and the operation of the control signal output circuit to output the external equipment control signal to the external equipment and the operation of controlling the operations of the image display apparatus based on the input control signal detected by the control signal input circuit can be enabled or disabled using the menu function.

Further, it is preferable that the at least one external-equipment-link unit includes a control signal state monitor circuit, so that when the control unit controls the control signal output circuit to output the external equipment control signal to the external equipment, the control unit simultaneously controls the control signal state monitor circuit to monitor a state of the external equipment control signal, and the control unit controls the control signal output circuit to stop outputting the external equipment control signal when the external equipment control signal is in an abnormal state. Consequently, when an external circuit incompatible with the rating is connected to the control signal output circuit, a risk of accidents can be reduced and the reliability of the image display apparatus can be improved.

Further, the control signal input circuit may be connected such that the detected input control signal also is supplied to the control signal state monitor circuit, and when the control unit controls the control signal state monitor circuit to monitor the state of the external equipment control signal, the control unit also controls the control signal input circuit to detect the input control signal.

Hereinafter, the image display apparatus of the present invention will be described in detail by way of embodiments with reference to the drawings.

### Embodiment 1

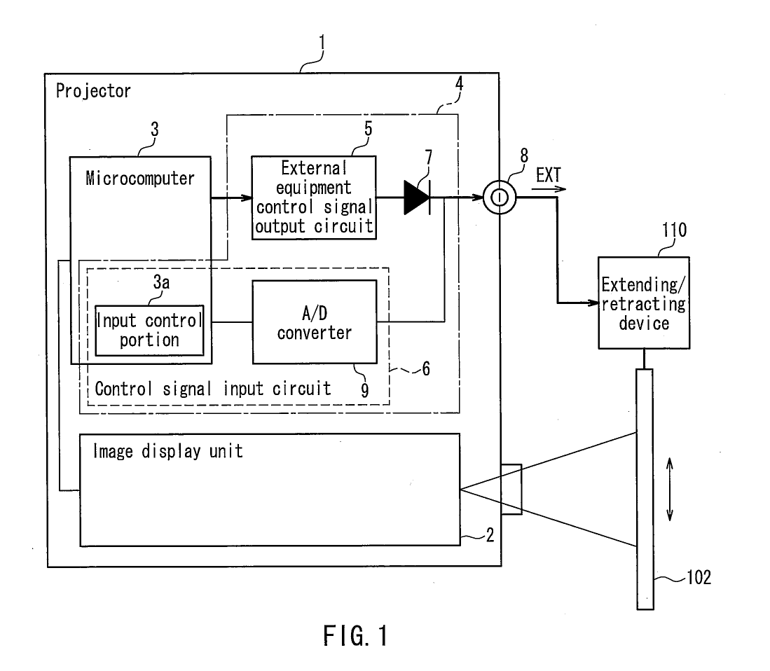

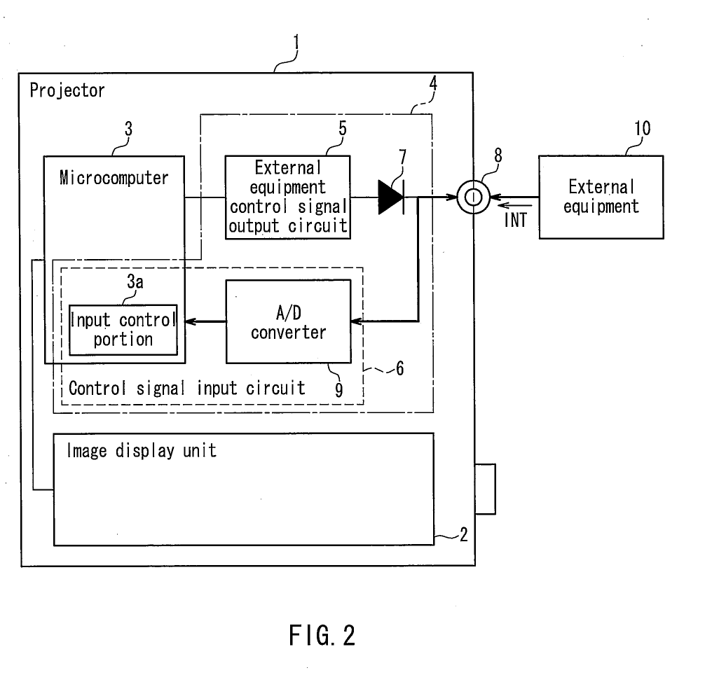

A configuration and operations of an image display apparatus with an external-equipment-link unit of Embodiment 1 will be described with reference to FIGS. 1 and 2. In the present embodiment, the image display apparatus is a projector 1 and the external-equipment-link unit has a configuration for achieving link control, which allows not only control of external equipment from the projector 1 but also control of the projector 1 from the external equipment. FIGS. 1 and 2 show different operations of the projector 1 by the external-equipment-link unit.

FIGS. 1 and 2 are block diagrams each showing a configuration of the projector 1. The projector 1 includes an image display unit 2 for forming and displaying an optical image. Because the image display unit 2 has a well-known configuration, the detailed description thereof will be omitted. Other well-known components also are not shown in the drawings and the description thereof will be omitted. The projector 1 is provided with a microcomputer 3 as a control circuit (control unit) for controlling operations of the entire apparatus including the image display unit 2. The projector 1 further is provided with an external-equipment-link unit 4. The microcomputer 3 is configured to function also as a control circuit for the external-equipment-link unit 4.

The external-equipment-link unit 4 is composed of an external equipment control signal output circuit 5, a control signal input circuit 6, a diode 7 and a control signal input/output terminal 8. The control signal input circuit 6 is composed of an input control portion 3a as a part of the functions of the microcomputer 3 and an A/D converter 9. The diode 7 is an element for providing the function of separating an input control signal from an external equipment control signal that are inputted and outputted through the input/output terminal 8, respectively. In the configuration as described above, the external-equipment-link unit 4 includes a pair of one control signal output circuit 5 and one control signal input circuit 6.

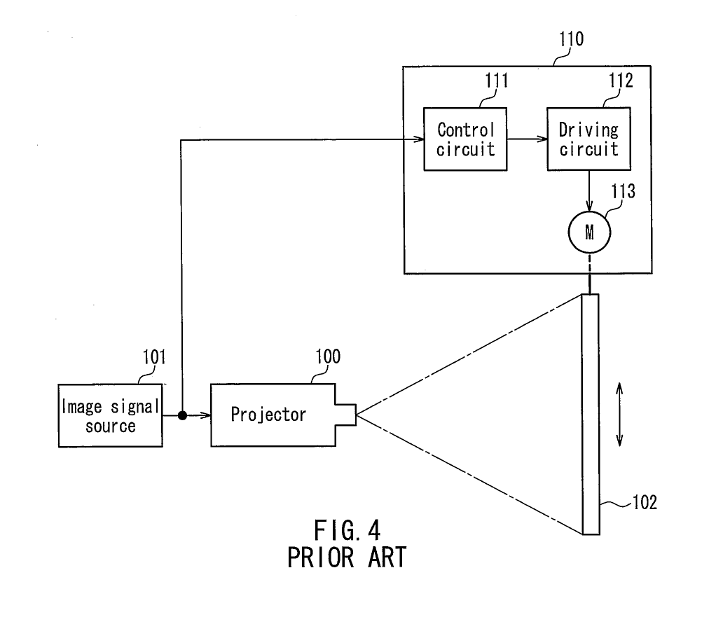

FIG. 1 shows operations when controlling external equipment from the projector 1. FIG. 1 shows a case in which a screen 102 and an extending/retracting device 110 for extending/retracting the screen are provided as the external equipment. The extending/retracting device 110 has the same configuration as that shown in FIG. 4. The same components as those shown in FIG. 4 are denoted by the same reference numerals and the detailed description thereof will not be repeated.

A description will be given of operations of the external-equipment-link unit 4 having the above-described configuration in combination with the external equipment (the screen 102 and the extending/retracting device 110) in FIG. 1. In this case, the microcomputer 3 is set to a mode for allowing the projector 1 to output an external equipment control signal and when determining that the projector 1 is in a predetermined operation state, the microcomputer 3 causes the external equipment control signal output circuit 5 to output an external equipment control signal EXT. The external equipment control signal EXT passes through the input/output terminal 8 and is inputted to the extending/retracting device 110. The extending/retracting device 110 extends the screen 102 in response to the reception of the external equipment control signal EXT.

Further, when the microcomputer 3 determines that the projector 1 is not in a predetermined operation state, the microcomputer 3 controls the external equipment control signal output circuit 5 to stop outputting the external equipment control signal EXT. When the reception of the external equipment control signal EXT stops, the extending/retracting device 110 retracts the screen 102.

In this way, extension/retraction of the screen 102 can be controlled from the projector 1. The operations that have been described are the same operations as those of the external equipment control units of the conventional image display apparatuses.

Here, “the predetermined operation state of the projector 1” which is applied for determining the external equipment control signal EXT to be outputted or stopped can be set appropriately by the designer and it may be a state in which the projector 1 is ON or the projector 1 is receiving a specific image signal. In other words, the operation state of the projector 1 as a trigger for outputting the external equipment control signal EXT is not particularly limited.

Now referring to FIG. 2, a description will be given of a case where an external device 10 capable of externally controlling operations of the projector 1 is placed as the external equipment. Note that the same components as those of FIG. 1 are denoted by the same reference numerals and the detailed description thereof will not be repeated.

As shown in FIG. 2, the external device 10 is connected to the input/output terminal 8. As for the external-equipment-link unit 4 of the present embodiment, the input/output terminal 8 functions as both an output terminal for the external equipment control signal EXT and an input terminal for an input control signal INT. For this reason, the control signal on the input side and that on the output side are separated from each other by the diode 7 so that the input control signal INT is not inputted to the external equipment control signal output circuit 5.

In the state shown in FIG. 2, the microcomputer 3 is set to a mode for allowing the projector 1 to receive the input control signal INT from the external device 10. Thus, the microcomputer 3 causes the control signal input circuit 6 to process the input control signal INT received from the external device 10 through the input/output terminal 8. That is the input control signal INT is converted by the A/D converter 9 into a digital signal and is detected continuously by the input control portion 3a. When the input control signal INT detected by the input control portion 3a meets set conditions, the microcomputer 3 controls the projector 1 to enter a predetermined operation state.

Here, “the predetermined operation state” where the projector 1 is controlled to enter by the microcomputer 3 may be a state where a lamp of the projector 1 is turned on, an image signal is muted or input signals are switched, and may be any operation controllable from the external equipment. That is, “the predetermined operation state” can be set appropriately by the designer and the operation of the projector 1 to be controlled is not particularly limited. Although it has been described that the A/D converter 9 and the microcomputer 3 (input control portion 3a) are used to form the control signal input circuit 6, other components may be used to detect the input control signal INT.

The external-equipment-link unit of the image display apparatus according to the present embodiment as described above may also include a plurality of pairs of the external equipment control signal output circuits 5 and the control signal input circuits 6. In that case, with respect to each pair, the operations of the external equipment control signal output circuit and the control signal input circuit can be controlled independently. In other words, it is possible independently to enable and disable generation of the external equipment control signal EXT to external equipment and to enable and disable control of operations of the projector 1 based on the input control signal INT inputted from the external equipment.

As the form of controlling enablement and disablement of the operations, items for selecting as such may be included in a menu of the image display apparatus. As a result, even when one pair of the circuits of the external-equipment-link unit is set to an output mode, it is easy to operate setting the other pair of the circuits to an input mode. Hence, it is possible to extend the range of applications of the system configuration centered on the projector 1.

In the above-described configuration, a single terminal serves as both a terminal for the external equipment control signal EXT and a terminal for the input control signal INT. The present invention, however, is not limited to this configuration. Terminals may be provided both for the external equipment control signal EXT and the input control signal INT, respectively.

As described above, since the image display apparatus according to the present embodiment is provided with the external-equipment-link unit having the function of inputting a control signal as well as the function of outputting a control signal, operations of the projector can be controlled externally. As a result, for example, the power of the projector can be turned on/off at once with the power of other equipment. In this way, not only extension/retraction of a screen can be controlled as conventionally, but also systematic control such as control of the illumination, curtains and the projector can be performed. This can improve user convenience significantly.

### Embodiment 2

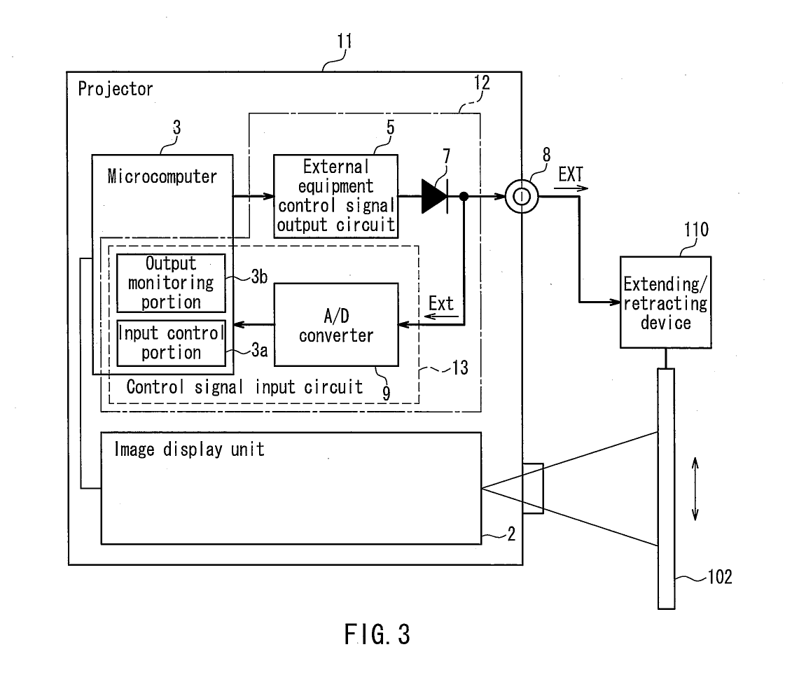

FIG. 3 is a block diagram showing an exemplary configuration of an image display apparatus with an external-equipment-link unit according to Embodiment 2. The present embodiment also shows a case where the image display apparatus is a projector 11. The same components as those of FIG. 1 are denoted by the same reference numerals and the detailed description thereof will not be repeated. Also in the configuration shown in FIG. 3, an external-equipment-link unit 12 includes a pair of a control signal output circuit 4 and a control signal input circuit 13.

The external-equipment-link unit 12 shown in FIG. 3 includes the same components as those of the external-equipment-link unit 4 shown in FIG. 1. However, the microcomputer 3 includes an output monitoring portion 3b in addition to the input control portion 3a as elements of the external-equipment-link unit 12. Further, the external-equipment-link unit 12 is configured such that the external equipment control signal EXT is inputted to the output monitoring portion 3b using the A/D converter 9 of the control signal input circuit 13 at the same time as outputting the external equipment control signal EXT externally.

Generally, ratings are specified for external equipment to be connected to the external equipment control signal output circuit 5. In other words, external equipment to be connected can be used safely if its rating is within a specified rating range. However, it is not always possible to control the specifications of external equipment that users may connect to the input/output terminal 8 of the projector 11. If a user connects, to a terminal, external equipment incompatible with the rating, an overcurrent may flow into the external equipment control signal output circuit 5 depending on the conditions, and accidents such as breakage of the circuit may occur.

For this reason, the external-equipment-link unit 12 in the present embodiment is provided with a mechanism for monitoring the state of the external equipment control signal EXT. That is, by using the components for detecting the input control signal INT, the A/D converter 9 and the output monitoring portion 3b are configured to monitor the state of the external equipment control signal EXT while the external equipment control signal output circuit 5 outputs the external equipment control signal EXT.

When external equipment incompatible with the rating, for example, external equipment with a small input impedance is connected to the terminal, the voltage of the external equipment control signal EXT does not rise to a certain value and only a current flows. Hence, there is a risk of an increase in the power loss of the external equipment control signal output circuit 5. In order to avoid this problem, the voltage value of the external equipment control signal EXT is monitored by the A/D converter 9 and the output monitoring portion 3b so as to detect an abnormal state such as the voltage of the external equipment control signal EXT not having risen to a certain value.

When the microcomputer 3 detects that the external equipment control signal EXT is in an abnormal state, the microcomputer 3 causes the external equipment control signal output circuit 5 to stop outputting the external equipment control signal EXT, so that accidents such as breakage of the circuit can be avoided.

As described above, since the external-equipment-link unit of the image display apparatus in the present embodiment is configured to monitor the state of the external equipment control signal while the external equipment control signal being outputted, it is possible to detect the abnormal state of the external equipment control signal. As a result, the reliability of the projector can be improved. Further, in the present embodiment, the state of the external equipment control signal is detected using the components for detecting the input control signal. Thus, the desired function can be achieved without an increase in cost. It is apparent that the external equipment control signal can be detected using a detection circuit designed specifically for detecting the external equipment control signal.

The invention may be embodied in other forms without departing from the spirit of essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An image display apparatus comprising:
an image display unit for forming and displaying an optical image;
an external-equipment-link unit capable of sending/receiving a control signal to/from external equipment; and
a control unit for controlling operations of the image display unit and the external-equipment-link unit,
wherein the external-equipment-link unit includes at least one control signal output circuit and at least one control signal input circuit,
the control signal input circuit detects an input control signal inputted from the external equipment and supplies the input control signal to the control unit,
the control unit controls the control signal output circuit to output an external equipment control signal to the external equipment in response to the image display apparatus being in a predetermined operation state, and
the control unit controls operations of the image display apparatus based on the input control signal supplied from the control signal input circuit.

2. The image display apparatus according to claim 1, wherein the operation of the control signal output circuit to output the external equipment control signal to the external equipment and the operation of controlling operations of the image display apparatus based on the input control signal detected by the control signal input circuit can be enabled or disabled independently.

3. The image display apparatus according to claim 2, wherein the external-equipment-link unit includes a plurality of pairs of the control signal output circuits and the control signal input circuits, and
for each pair of the control signal output circuit and the control signal input circuit, the operation of the control signal output circuit to output the external equipment control signal to the external equipment and the operation of controlling the operations of the image display apparatus based on the input control signal detected by the control signal input circuit can be enabled or disabled independently.

4. The image display apparatus according to claim 1, wherein the image display apparatus has a menu function for selecting the operations of the image display apparatus, and
the operation of the control signal output circuit to output the external equipment control signal to the external equipment and the operation of controlling the operations of the image display apparatus based on the input control signal detected by the control signal input circuit can be enabled or disabled using the menu function.

5. The image display apparatus according to claim 1, wherein the at least one external-equipment-link unit includes a control signal state monitor circuit,
when the control unit controls the control signal output circuit to output the external equipment control signal to the external equipment, the control unit simultaneously controls the control signal state monitor circuit to monitor a state of the external equipment control signal, and
the control unit controls the control signal output circuit to stop outputting the external equipment control signal when the external equipment control signal is in an abnormal state.

6. The image display apparatus according to claim 5, wherein the control signal input circuit is connected such that the detected input control signal is also supplied to the control signal state monitor circuit, and
when the control unit controls the control signal state monitor circuit to monitor the state of the external equipment control signal, the control unit also controls the control signal input circuit to detect the input control signal.
